(19) United States
(12) Patent Application Publication
(10) Pub. No.: US 2011/0254763 A1
(43) Pub. Date: Oct. 20, 2011

(54) Optical pointing module and electronic apparatus

(75) Inventors: Sang Jin Lee, Seoul (KR); Kwang Cheol Cho, Yongin (KR); Seung Hoon Han, Suwon (KR)

(73) Assignee: Samsung Electro-Mechanics Co., Ltd., Suwon (KR)

(21) Appl. No.: 12/929,041

(22) Filed: Dec. 23, 2010

(30) Foreign Application Priority Data
Apr. 14, 2010 (KR) 10-2010-0034235

(51) Int. Cl. G06F 3/033; H01J 40/14

(52) U.S. Cl. 345/157; 250/221

(57) ABSTRACT

Disclosed are an optical pointing module and an electronic apparatus that are reduced in size in order to be used in a personal portable terminal. An optical pointing module according to an aspect of the invention may include: a laser light source mounted on a printed circuit board; an outer housing through which laser light, emitted from the laser light source, is transmitted; a light receiving unit located on the printed circuit board, receiving the laser light being reflected from the outer housing by an external stimulus, and transmitting an electrical signal to an integrated circuit; and an inner housing received in the outer housing and having a passage recess, through which the laser light passes, and a contact surface coming into contact with an inner surface of the outer housing, the contact surface having a height different from that of a surface of the inner housing having the passage recess therein.

### CROSS-REFERENCE TO RELATED APPLICATIONS

This application claims the priority of Korean Patent Application No. 10-2010-0034235 filed on Apr. 14, 2010, in the Korean Intellectual Property Office, the disclosure of which is incorporated herein by reference.

### BACKGROUND OF THE INVENTION

1. Field of the Invention

The present invention relates to an optical pointing module and an electronic apparatus, and more particularly, to an optical pointing module and an electronic apparatus that are reduced in size in order to be used in a personal portable terminal.

2. Description of the Related Art

In general, personal mobile terminals, such as cellular phones or smartphones, have been employing user interfaces using keypads, which consist of a set of buttons in order to input numbers and letters as well as directional buttons.

Furthermore, in line with the commercialization of wireless Internet services such as wireless broadband (WIBRO) services, an operating system of a graphical user interface (GUI), which allows a user to perform an operation through the use of graphics, has been used in a personal mobile terminal when the user exchanges information with a computer.

That is, the GUI, which allows the user to perform an operation by selecting a menu on a screen, is used as a user interface of a personal mobile terminal by using a mouse or the like, there is an urgent need for an input device appropriate for the personal mobile terminal.

Correspondingly, touch keys, joysticks, and the like using an improved mono method of making a selection in a sequential manner, such as a keypad, on a display screen of a personal mobile terminal have appeared.

However, since these touch keys and joysticks in the related art physically take up space, they are difficult to apply to small, thin devices.

### SUMMARY OF THE INVENTION

An aspect of the present invention provides an optical pointing module and an electronic apparatus that are reduced in size in order to be applied in a personal mobile terminal.

According to an aspect of the present invention, there is provided an optical pointing module including: a laser light source mounted on a printed circuit board; an outer housing through which laser light, emitted from the laser light source, is transmitted; a light receiving unit located on the printed circuit board, receiving the laser light being reflected from the outer housing by an external stimulus, and transmitting an electrical signal to an integrated circuit; and an inner housing received in the outer housing and having a passage recess, through which the laser light passes, and a contact surface coming into contact with an inner surface of the outer housing, the contact surface having a height different from that of a surface of the inner housing having the passage recess therein.

The surface of the inner housing, in which the passage recess is provided, may be dented on the contact surface.

A light transmission hole through which the laser light, emitted from the laser light source, is transmitted and a light-receiving hole through which the laser light, reflected from the outer housing, is received may be provided in a bottom surface of the passage recess of the inner housing.

The light-receiving hole may include an image sensor receiving the laser light, reflected from the outer housing.

The inner housing may be formed of polycarbonate.

The laser light source may be a vertical-cavity surface-emitting laser (VCSEL).

A dome switch provided in a lower surface of the printed circuit board may further be included.

An area of the light-receiving hole may be greater than that of the light transmission hole.

According to another aspect of the present invention, there is provided an optical pointing module including: a laser light source mounted on a printed circuit board; an outer housing through which laser light, emitted from the laser light source, is transmitted; a light receiving unit located on the printed circuit board, receiving the laser light, reflected from the outer housing by an external stimulus, and transmitting an electrical signal to an integrated circuit; and an inner housing received in the outer housing and having a passage recess through which the laser light passes, the inner housing having a transmission hole, through which the laser light, emitted from the laser light source, is transmitted, and a light-receiving hole receiving the laser light, reflected from the outer housing, is received, in a bottom surface of the passage recess.

An opening surface may be provided in the bottom surface of the passage recess of the inner housing and have a predetermined inclination from the bottom surface of the passage recess to the light-receiving hole along a circumference of the light-receiving hole.

An opening surface may be provided in the bottom surface of the passage recess of the inner housing and have a predetermined inclination from the bottom surface of the passage recess to the light transmission hole along a circumference of the light transmission hole.

The light receiving unit may include an image sensor receiving the laser light, reflected from the outer housing.

The inner housing may be formed of polycarbonate.

The laser light source may be a vertical-cavity surface-emitting laser (VCSEL).

The inner housing may further include a contact surface coming into contact with an inner surface of the outer housing, and a surface of the inner housing, in which the passage recess is provided, may be dented on the contact surface.

A dome switch, provided on a bottom surface of the printed circuit board, may further be included.

An area of the light-receiving hole may be greater than that of the light transmission hole.

According to another aspect of the present invention, there is provided an electronic apparatus including: an optical pointing module comprising a laser light source mounted on a printed circuit board, an outer housing through which laser light, emitted from the laser light source, is transmitted, a light receiving unit located on the printed circuit board, receiving the laser light, reflected from the outer housing by an external stimulus, and transmitting an electrical signal to an integrated circuit, and an inner housing received in the outer housing, and having a passage recess, through which the laser light passes, and a contact surface coming into contact with an inner surface of the outer housing, the contact surface having a height different from that of a surface in which the passage recess is provided; a casing accommodating the optical pointing module and exposing the outer housing to an outside thereof; and a display displaying an image according to signal processing of the integrated circuit of the optical pointing module.

The surface of the inner housing, in which the passage recess is provided, may be dented on the contact surface.

A light transmission hole, through which the laser light, emitted from the laser light source, is transmitted, and a light-receiving hole through which the laser light, reflected from the outer housing, is received, may be provided in a bottom surface of the passage recess.

The light receiving unit may include an image sensor receiving the laser light reflected from the outer housing.

The inner housing may be formed of polycarbonate.

The laser light source may be a vertical-cavity surface-emitting laser (VCSEL).

A dome switch, provided in a bottom surface of the printed circuit board, may further be included.

An area of the light-receiving hole may be greater than that of the light transmission hole.

According to another aspect of the present invention, there is provided an electronic apparatus including: an optical pointing module comprising an optical laser source mounted on a printed circuit board, an outer housing through which laser light, emitted from the laser light source, is transmitted, a light receiving unit located on the printed circuit board, receiving the laser light, reflected from the outer housing by an external stimulus, and transmitting an electrical signal to an integrated circuit, and an inner housing having a light transmission hole through which the laser light, emitted from the laser light source, is transmitted, and a light-receiving hole, through which the laser light, reflected from the outer housing, is received, in a bottom surface of the passage recess; a casing receiving the optical pointing module and exposing the outer housing to an outside thereof; and a display displaying an image according to signal processing of the integrated circuit of the optical pointing module.

An opening surface having a predetermined inclination from the bottom surface of the passage recess to the light-receiving hole along a circumference of the light-receiving hole may be provided in the bottom surface of the passage recess of the inner housing.

An opening surface having a predetermined inclination from the bottom surface of the passage recess to the light transmission hole along a circumference of the light transmission hole may be provided in the bottom surface of the passage recess.

The light receiving unit may include an image sensor receiving the laser light reflected from the outer housing of the inner housing.

The inner housing may be formed of polycarbonate.

The laser source may be a vertical-cavity surface emitting laser (VCSEL).

The inner housing may include a contact surface coming into contact with an inner surface of the outer housing, and a surface of the inner housing, in which the passage recess is provided, may be dented on the contact surface.

A dome switch, provided in a lower surface of the printed circuit board, may further be included.

An area of the light-receiving hole may be greater than that of the light transmission hole.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an optical pointing module according to an exemplary embodiment of the present invention;

FIG. 2 is a lower perspective view schematically illustrating an optical pointing module according to an exemplary embodiment of the present invention;

FIG. 3 is a schematic exploded perspective view illustrating an optical pointing module according to an exemplary embodiment of the present invention;

FIG. 4 is a schematic sectional view illustrating an optical pointing module according to an exemplary embodiment of the present invention;

FIG. 5 is an upper view illustrating an inner housing of an optical pointing module according to an exemplary embodiment of the present invention; and

FIG. 6 is a schematic perspective view illustrating an electronic apparatus using an optical pointing module according to an exemplary embodiment of the present invention.

### DETAILED DESCRIPTION OF THE PREFERRED EMBODIMENT

Exemplary embodiments of the present invention will now be described in detail with reference to the accompanying drawings.

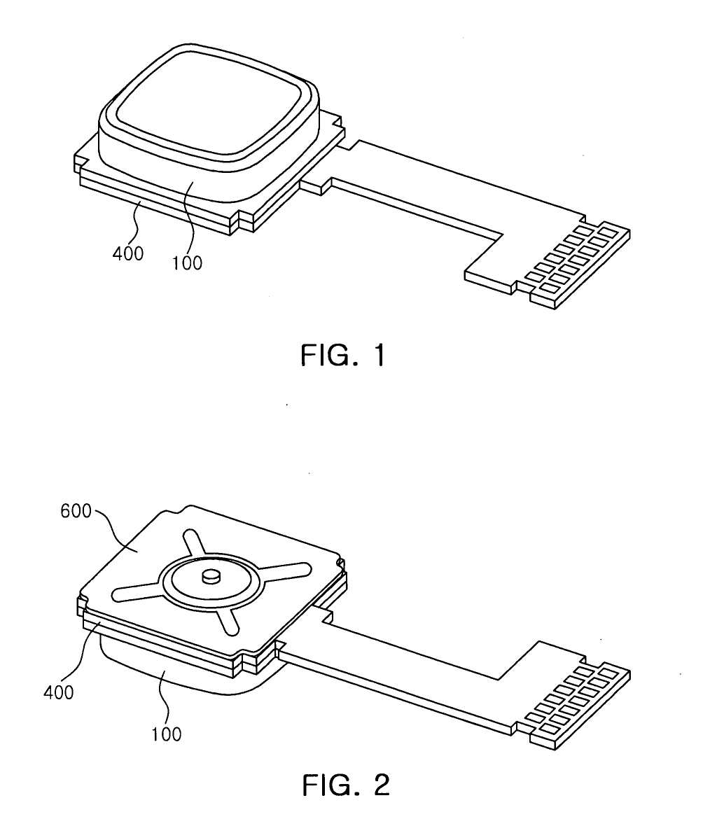

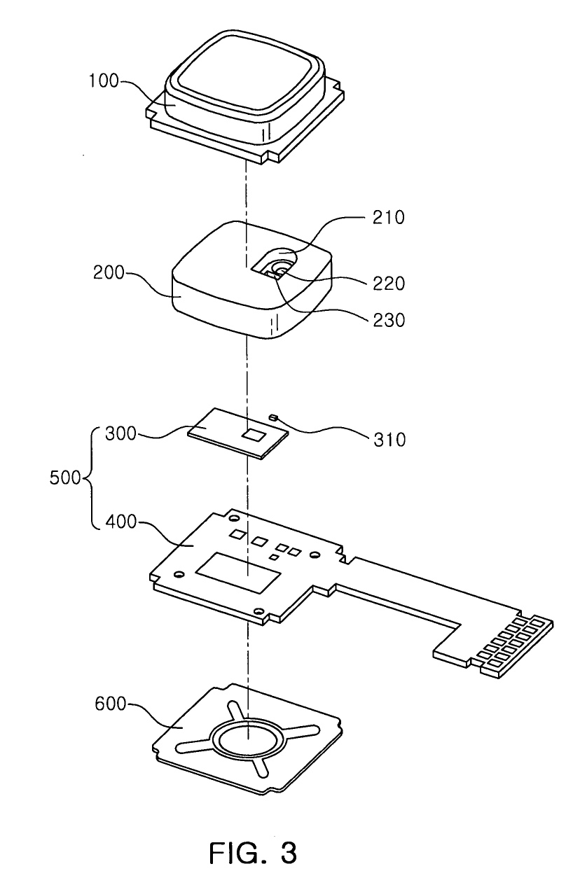

FIG. 1 is a schematic perspective view illustrating an optical pointing module according to an exemplary embodiment of the invention. FIG. 2 is a lower perspective view schematically illustrating an optical pointing module according to an exemplary embodiment of the invention. FIG. 3 is a schematic exploded perspective view illustrating an optical pointing module according to an exemplary embodiment of the invention.

Referring to FIGS. 1 through 3, an optical pointing module according to this embodiment may include an outer housing 100, an inner housing 200, a light receiving unit 500, and a dome switch 600.

Laser light, emitted from a laser light source 310 to be described below, is transmitted through the outer housing 100. An external stimulus is input to the outer housing 100.

The outer housing 100 accommodates the inner housing 200 and the light receiving unit 500, which form the optical pointing module according to this embodiment, and may be shaped like a cap with an opening in one surface thereof.

An upper surface of the outer housing 100 has a transmissive area through which light is transmitted. In terms of increasing durability and workability, the outer housing 100 may be manufactured by injection molding.

Furthermore, the outer housing 100 is not limited to a square shape as this embodiment. The shape of the outer housing 100 can be modified by a person skilled in the art without departing from the spirit of the invention.

The inner housing 200 is received inside the outer housing 100 and may have a passage recess 210 in an upper surface thereof coming into contact with the outer housing 100. The laser light passes through the passage recess 210. Here, the inner housing 210 is projected by partition walls. However, the invention is not limited thereto.

An inner surface 215 of the passage recess 210 serves to shield external light when laser light, emitted from the laser light source 310 to be described below, is reflected from the outer housing 100 and is received in an image sensor (not shown) of an integrated circuit 300.

Furthermore, in the same manner as the inner surface 215 of the passage recess 210, an outer surface of the inner housing 200 that comes in contact with the inner surface of the outer housing 100 serves to shield external light.

The laser light, reflected from the outer housing 100, is received in the image sensor (not shown) of the light receiving unit 500 and computes a position on a display (not shown) of an electronic apparatus by the integrated circuit 300.

Here, the inflow of external light hinders the operation of computing a position through the integrated circuit 300, and thus it becomes impossible to indicate an accurate position thereof on the display (not shown).

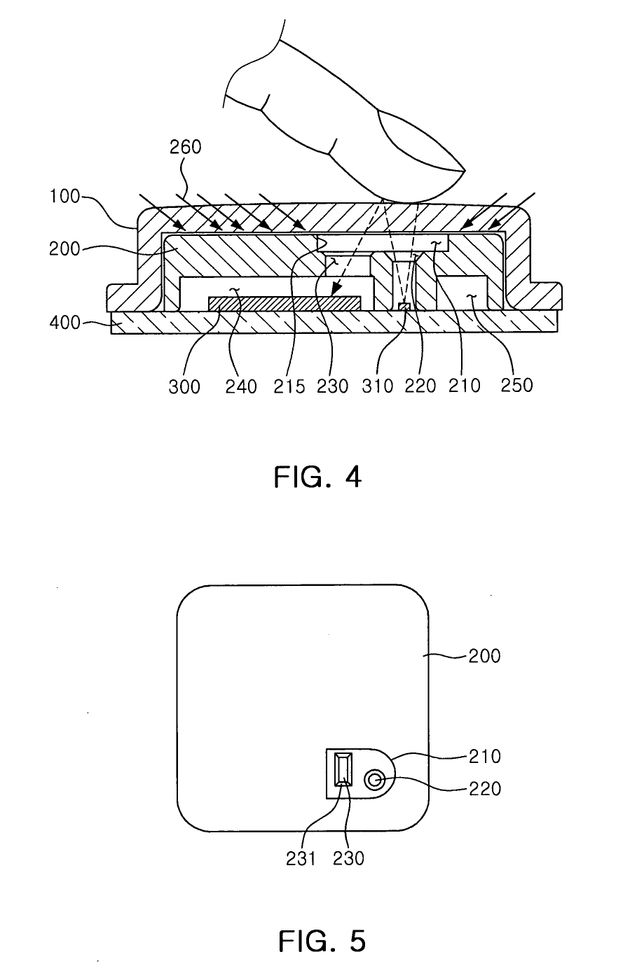

Therefore, the external light is shielded by the outer surface of the inner housing 200, which comes into contact with the inner surface of the outer housing 100, and the inner surface 215 of the passage recess 210. A description of the passage recess 210 will be made below with reference to FIG. 4.

The passage recess 210 of the inner housing 200 may have a light transmission hole 220 and a light-receiving hole 230.

The light transmission hole 220 is formed in a bottom surface of the passage recess 210 and serves as a path through which laser light, emitted from the laser light source 310, is made incident upon the outer housing 100. The laser light, passing through the light transmission hole 220, is transmitted through a predetermined region of the outer housing 100.

The light transmission hole 220 may have a circular shape but the present invention is not limited thereto.

The light-receiving hole 230 is also formed in the bottom surface of the passage recess 212 and serves as a path through which laser light, being transmitted through the outer housing 100, is reflected by an external stimulus and received in the image sensor (not shown). The light-receiving hole 230 may have a square shape, but the present invention is not limited thereto.

The receiving recess 240 is a space in which the light receiving unit 500 is received, and will be described below with reference to FIG. 4.

The light receiving unit 500 may include the integrated circuit 300 and a circuit board 400. The integrated circuit 300 may include the image sensor (not shown).

The image sensor (not shown) of the integrated circuit 300 receives the laser light, passing through the light-receiving hole 230 of the inner housing 200 and computes a position value on a display (not shown) to thereby indicate an accurate position on the display (not shown).

The circuit board 400 transmits an electrical signal of the integrated circuit 300 to the display (not shown) in order to indicate an accurate position on the display (not shown).

A laser light source 310, which becomes a source of laser light, may be located on the circuit board 400.

The laser light source 310 may be a vertical-cavity surface-emitting laser (VCSEL). Hereinafter, the laser light source 310 may also be referred to as a vertical-cavity surface-emitting laser 310.

The vertical-cavity surface-emitting laser 310 is a type of laser diode that converts an electrical signal into an optical signal.

The vertical-cavity surface-emitting laser 310 is anew light source that will replace an existing lateral light emitting semiconductor (FP or DFB). The vertical-cavity surface-emitting laser 310 replaces a photoelectric sensor such as an infrared light emitting diode (LED) sensor module, thereby manufacturing a precision photoelectric sensor.

The laminated ceramic condenser 320 is a kind of condenser, that is, a chip-type condenser having a multilayered structure with dielectric layers and electrodes provided as small thin films according to the purpose of rated voltage and capacitance. The laminated ceramic condenser 320 serves to stably supply electricity as the need arises.

The dome switch 600 may be located under the circuit board 400 in order to indicate an accurate position on the display (not shown) by the external stimulus.

Referring to FIG. 4, the inner housing 200, as described above, may include the receiving recess 240 in addition to the passage recess 210, the light transmission hole 220, and the light-receiving hole 230.

In an optical pointing module, the receiving recess 240 is a space in which accessory devices are located. The size and kind of the accessory devices may be varied according to an electronic apparatus including the above-described optical pointing module.

Furthermore, the inner housing 200 may be received in the outer housing 100 and come into contact with the inner surface of the outer housing 100 except for the passage recess 210, the light transmission hole 220, the light-receiving hole 230, and the receiving recess 240.

As described above, external light is thereby shielded by the outer surface of the inner housing 200 that comes into contact with the inner surface of the outer housing 100.

Here, the inner housing 200 may be formed of polycarbonate. Polycarbonate, which is resins made by polymerizing carbonates, is as strong as a metal while being acid and heat-resistant.

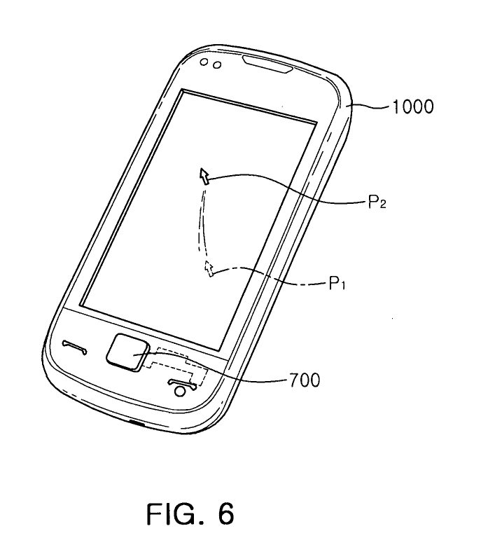

FIG. 5 is a view illustrating an upper view illustrating an inner housing of an optical pointing module according to an exemplary embodiment of the invention. FIG. 6 is a schematic perspective view illustrating an electronic apparatus using an optical pointing module according to an exemplary embodiment of the invention.

As shown in FIG. 5, the inner housing 200 of the optical pointing module according to this embodiment has the passage recess 210, which is recessed to be lower than the outer surface thereof that comes into contact with the inner surface of the outer housing 100. The passage recess 210 may have the light transmission hole 220 through which laser light is transmitted and the light-receiving hole 230 in which laser light, reflected by an external stimulus such as a finger located on the surface of the outer housing 100.

The light transmission hole 220 may have an opening surface 221 that is inclined toward the light transmission hole 220 along the circumference of the light transmission hole 220 from the bottom surface in which the passage recess 210 is formed. The light-receiving hole 230 may have an opening surface 231 that is inclined toward the light-receiving hole 230 along the circumference of the light-receiving hole 230.

In terms of the directionality of laser light and receiving reflected laser light, the area of the light-receiving hole may be larger than that of the light transmission hole.

Referring to FIG. 6, an electronic apparatus using an optical pointing module according to an exemplary embodiment of the invention, in particular, a mobile communications terminal 1000 can display an image, appearing on a display of the mobile communications terminal 1000, by providing a stimulus using a finger on an outer housing of an optical pointing module 700. In particular, positions p1 and p2 of a cursor on the display of the mobile communications terminal 1000 can be moved.

As set forth above, according to exemplary embodiments of the invention, as an optical pointing module and an electronic apparatus can be reduced in size in order to be used in a personal mobile terminal, they are reduced in size, weight, and thickness.

While the present invention has been shown and described in connection with the exemplary embodiments, it will be apparent to those skilled in the art that modifications and variations can be made without departing from the spirit and scope of the invention as defined by the appended claims.

What is claimed is:

1. An optical pointing module comprising:
a laser light source mounted on a printed circuit board;
an outer housing through which laser light, emitted from the laser light source, is transmitted;
a light receiving unit located on the printed circuit board, receiving the laser light being reflected from the outer housing by an external stimulus, and transmitting an electrical signal to an integrated circuit; and
an inner housing received in the outer housing and having a passage recess, through which the laser light passes, and a contact surface coming into contact with an inner surface of the outer housing, the contact surface having a height different from that of a surface of the inner housing having the passage recess therein.

2. The optical pointing module of claim 1, wherein the surface of the inner housing, in which the passage recess is provided, is dented on the contact surface.

3. The optical pointing module of claim 1, wherein a light transmission hole through which the laser light, emitted from the laser light source, is transmitted and a light-receiving hole through which the laser light, reflected from the outer housing, is received are provided in a bottom surface of the passage recess of the inner housing.

4. The optical pointing module of claim 1, wherein the light-receiving hole comprises an image sensor receiving the laser light, reflected from the outer housing.

5. The optical pointing module of claim 1, wherein the inner housing is formed of polycarbonate.

6. The optical pointing module of claim 1, wherein the laser light source is a vertical-cavity surface-emitting laser (VCSEL).

7. The optical pointing module of claim 1, wherein a dome switch, provided in a lower surface of the printed circuit board, is further included.

8. The optical pointing module of claim 3, wherein an area of the light-receiving hole is greater than that of the light transmission hole.

9. An optical pointing module comprising:
a laser light source mounted on a printed circuit board;
an outer housing through which laser light, emitted from the laser light source, is transmitted;
a light receiving unit located on the printed circuit board, receiving the laser light, reflected from the outer housing by an external stimulus, and transmitting an electrical signal to an integrated circuit; and
an inner housing received in the outer housing and having a passage recess through which the laser light passes, the inner housing having a transmission hole, through which the laser light, emitted from the laser light source, is transmitted, and a light-receiving hole receiving the laser light, reflected from the outer housing, is received, in a bottom surface of the passage recess.

10. The optical pointing module of claim 9, wherein an opening surface is provided in the bottom surface of the passage recess of the inner housing and has a predetermined inclination from the bottom surface of the passage recess to the light-receiving hole along a circumference of the light-receiving hole.

11. The optical pointing module of claim 9, wherein an opening surface is provided in the bottom surface of the passage recess of the inner housing and has a predetermined inclination from the bottom surface of the passage recess to the light transmission hole along a circumference of the light transmission hole.

12. The optical pointing module of claim 9, wherein the light receiving unit comprises an image sensor receiving the laser light, reflected from the outer housing.

13. The optical pointing module of claim 9, wherein the inner housing is formed of polycarbonate.

14. The optical pointing module of claim 9, wherein the laser light source is a vertical-cavity surface-emitting laser (VCSEL).

15. The optical pointing module of claim 10, wherein the inner housing further comprises a contact surface coming into contact with an inner surface of the outer housing, and
a surface of the inner housing, in which the passage recess is provided, is dented on the contact surface.

16. The optical pointing module of claim 11, wherein the inner housing further comprises a contact surface coming into contact with an inner surface of the outer housing, and
a surface of the inner housing, in which the passage recess is provided, is dented on the contact surface.

17. The optical pointing module of claim 9, wherein a dome switch, provided on a bottom surface of the printed circuit board, is further included.

18. The optical pointing module of claim 9, wherein an area of the light-receiving hole is greater than that of the light transmission hole.

19. An electronic apparatus comprising:
an optical pointing module comprising a laser light source mounted on a printed circuit board, an outer housing through which laser light, emitted from the laser light source, is transmitted, a light receiving unit located on the printed circuit board, receiving the laser light, reflected from the outer housing by an external stimulus, and transmitting an electrical signal to an integrated circuit, and an inner housing received in the outer housing, and having a passage recess, through which the laser light passes, and a contact surface coming into contact with an inner surface of the outer housing, the contact surface having a height different from that of a surface in which the passage recess is provided;
a casing accommodating the optical pointing module and exposing the outer housing to an outside thereof; and
a display displaying an image according to signal processing of the integrated circuit of the optical pointing module.

20. The electronic apparatus of claim 19, wherein the surface of the inner housing, in which the passage recess is provided, is dented on the contact surface.

21. The electronic apparatus of claim 19, wherein a light transmission hole, through which the laser light, emitted from the laser light source, is transmitted, and a light-receiving hole through which the laser light, reflected from the outer housing, is received, are provided in a bottom surface of the passage recess.

22. The electronic apparatus of claim 19, wherein the light receiving unit comprises an image sensor receiving the laser light reflected from the outer housing.

23. The electronic apparatus of claim 19, wherein the inner housing is formed of polycarbonate.

24. The electronic apparatus of claim 19, wherein the laser light source is a vertical-cavity surface-emitting laser (VCSEL).

25. The electronic apparatus of claim 19, wherein a dome switch, provided in a bottom surface of the printed circuit board, is further included.

26. The electronic apparatus of claim 21, wherein an area of the light-receiving hole is greater than that of the light transmission hole.

27. An electronic apparatus comprising:
an optical pointing module comprising an optical laser source mounted on a printed circuit board, an outer housing through which laser light, emitted from the laser light source, is transmitted, a light receiving unit located on the printed circuit board, receiving the laser light, reflected from the outer housing by an external stimulus, and transmitting an electrical signal to an integrated circuit, and an inner housing having a light transmission hole through which the laser light, emitted from the laser light source, is transmitted, and a light-receiving hole, through which the laser light, reflected from the outer housing, is received, in a bottom surface of the passage recess;
a casing receiving the optical pointing module and exposing the outer housing to an outside thereof; and
a display displaying an image according to signal processing of the integrated circuit of the optical pointing module.

28. The electronic apparatus of claim 27, wherein an opening surface having a predetermined inclination from the bottom surface of the passage recess to the light-receiving hole along a circumference of the light-receiving hole is provided in the bottom surface of the passage recess of the inner housing.

29. The electronic apparatus of claim 27, wherein an opening surface having a predetermined inclination from the bottom surface of the passage recess to the light transmission hole along a circumference of the light transmission hole is provided in the bottom surface of the passage recess.

30. The electronic apparatus of claim 27, wherein the light receiving unit comprises an image sensor receiving the laser light reflected from the outer housing of the inner housing.

31. The electronic apparatus of claim 27, wherein the inner housing is formed of polycarbonate.

32. The electronic apparatus of claim 27, wherein the laser source is a vertical-cavity surface emitting laser (VCSEL).

33. The electronic apparatus of claim 28, wherein the inner housing comprises a contact surface coming into contact with an inner surface of the outer housing, and
a surface of the inner housing, in which the passage recess is provided, is dented on the contact surface.

34. The electronic apparatus of claim 29, wherein the inner housing comprises a contact surface coming into contact with an inner surface of the outer housing, and
a surface of the inner housing, in which the passage recess is provided, is dented on the contact surface.

35. The electronic apparatus of claim 27, wherein a dome switch, provided in a lower surface of the printed circuit board, is further included.

36. The electronic apparatus of claim 27, wherein an area of the light-receiving hole is greater than that of the light transmission hole.
